(19) United States
(12) Patent Application Publication
(10) Pub. No.: US 2026/0298749 A1
(43) Pub. Date: Oct. 1, 2026

(54) PRESSURE SENSOR

(71) Applicants: HYUNDAI MOTOR COMPANY, SEOUL (KR); KIA CORPORATION, SEOUL (KR); AMOGREENTECH CO., LTD., GIMPO-SI (KR)

(72) Inventors: Jang Hyeon Lee, Hwaseong-si (KR); Dong Gu Kim, Hwaseong-si (KR); Deok Woo Yun, Hwaseong-si (KR); Gwan Sik Kim, Hwaseong-si (KR); Kyong Hwa Song, Hwaseong-si (KR); Seok Min Lee, Hwaseong-si (KR); Yun Mi So, Incheon (KR); Geun Young Jang, Gimpo-si (KR); In Yong Seo, Seoul (KR)

(73) Assignees: HYUNDAI MOTOR COMPANY, SEOUL (KR); KIA CORPORATION, SEOUL (KR); AMOGREENTECH CO., LTD., GIMPO-SI (KR)

(21) Appl. No.: 19/379,230

(22) Filed: Nov. 4, 2025

(30) Foreign Application Priority Data
Mar. 31, 2025 (KR) 10-2025-0041737

(51) Int. Cl. G01L 9/02; G01L 9/06

(52) U.S. Cl. CPC G01L 9/025; G01L 9/06

(57) ABSTRACT

A pressure sensor may include a pressure sensing layer formed to sense a pressure, the pressure sensing layer having a temperature coefficient of resistance (TCR) according to a change in temperature which is a positive number or a negative number, and an electrode layer contacting the pressure sensing layer, the electrode layer having a TCR according to a change in temperature which is opposite to the TCR of the pressure sensing layer. The electrode layer may include a contact part stacked on the pressure sensing layer, and contacting the pressure sensing layer, and a lead part protruding from the contact part, and having either a serpentine shape or a spiral pattern.

### CROSS REFERENCE TO RELATED APPLICATIONS

This application claims the benefit of priority to Korean Patent Application No. 10-2025-0041737, filed in the Korean Intellectual Property Office on Mar. 31, 2025, the entire contents of which are incorporated herein by reference.

### TECHNICAL FIELD

The present disclosure relates to a pressure sensor.

### BACKGROUND

The pressure sensor is a device for sensing a pressure of a contacting object. In particular, a pressure sensor for sensing a pressure of a battery cell or the like may be classified into a pressure sensor for measuring a strain of a battery cell or a pressure sensor for measuring a surface pressure of a battery cell or the like.

In general, a pressure sensor for measuring a surface pressure of a battery cell or the like may be classified into a load cell (Load Cell) type or a force sensitive resistor (FSR) type, and the load cell type occupies a relatively large volume so that there may be a limitation in space.

Because the FSR type may take the form of a thin film and may be attached to a surface of a battery cell, it should be small and light weight. In particular, the FSR type may be used as a sensor for measuring a pressure of a battery cell because it may accurately measure swelling of the battery cell.

Meanwhile, a piezoresistive sensor is a resistive sensor known as an FSR, and because an electrical resistance value changes according to a change in a temperature of a battery cell or an ambient temperature, it may be necessary to compensate for a pressure value of the battery cell according to the change in the temperature of the battery cell or the ambient temperature.

### SUMMARY

The present disclosure has been made to solve the above-mentioned problems occurring in the prior art while advantages achieved by the prior art are maintained intact.

An aspect of the present disclosure provides a pressure sensor that may compensate for a pressure value according to temperature without a separate temperature sensor.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a pressure sensor may include a pressure sensing layer configured to sense a pressure, and having a temperature coefficient of resistance (TCR) according to a change in temperature which is a positive number or a negative number, and an electrode layer contacting the pressure sensing layer, and having a TCR according to a change in temperature is which is opposite to the TCR of the pressure sensing layer, and the electrode layer may include a contact part stacked on the pressure sensing layer, and contacting the pressure sensing layer, and a lead part protruding from the contact part, and having either a serpentine shape or a spiral pattern.

The TCR of the pressure sensing layer may be a negative number, and the TCR of the electrode layer may be a positive number.

The electrode layer may include a first electrode layer stacked on a first surface of the pressure sensing layer, and a second electrode layer stacked on a second surface of the pressure sensing layer, and an absolute value of the TCR of the pressure sensing layer may correspond to a sum of the TCR of the first electrode layer and the TCR of the second electrode layer.

The lead part may include a first lead connection area connected to the contact part, a pattern area having a wrinkled shape extending from the first lead connection area in a lengthwise direction of the lead part or a direction transverse to the lengthwise direction of the lead part, and a second lead connection area connected to the pattern area and disposed on an opposite side of the first lead connection area from the pattern area.

A width of the pattern area in the lengthwise direction of the lead part and the direction transverse to the lengthwise direction of the lead part may be smaller than each of a width of the first lead connection area in the direction transverse to the lengthwise direction of the lead part and a width of the second lead connection area in the direction transverse to the lengthwise direction of the lead part.

The pattern area may include a first pattern extending in a first direction along the lengthwise direction of the lead part from the first lead connection area, a second pattern connected to the first pattern, and extending in a second direction along the lead part, and a third pattern connected to the second pattern, and extending in the first direction along the lengthwise direction of the lead part.

One or more of the first pattern, the second pattern, and the third pattern may linearly extend along the lengthwise direction of the lead part or in the direction transverse to the lengthwise direction of the lead part, or include a wrinkled shape along the lengthwise direction of the lead part or in the direction transverse to the lengthwise direction of the lead part.

The first lead connection area and the second lead connection area may extend such that transverse directions of the first lead connection area and second lead connection area are lengthwise directions, and one or more of the first pattern, the second pattern, and the third pattern may include parts extending parallel to a lengthwise direction of the first lead connection area and a lengthwise direction of the second lead connection area.

The contact part may include a circular shape, and the lead part may include a pattern area extending spirally along a circumferential direction of the contact part, and a connection area extending to a radially outer side of the contact part from the pattern area.

According to an aspect of the present disclosure, a pressure sensor may include a first electrode layer including a first contact part and a first lead part extending from the first contact part in a first direction, a second electrode layer including a second contact part and a second lead part extending from the second contact part in a second direction being opposite the first direction and a pressure sensing layer positioned between the first electrode layer and the second electrode layer, and the pressure sensing layer may include a temperature coefficient of resistance (TCR) according to a change in temperature, and the first electrode layer may include a TCR according to a change in temperature, and the second electrode layer may include a TCR according to a change in temperature, and an absolute value of the TCR of the pressure sensing layer may correspond to a sum of the TCR of the first electrode layer and the TCR of the second electrode layer.

The pressure sensing layer, the first contact part, and the second contact part may each include a circular shape, and the first lead part and the second lead part may each have either a serpentine shape or a spiral pattern.

The first lead part may include a pattern area extending spirally along a circumferential direction of the first contact part, and a connection area extending to a radially outer side of the first contact part from the pattern area, and the second lead part may include a pattern area extending spirally along a circumferential direction of the second contact part, and a connection area extending to a radially outer side of the first contact part from the pattern area.

The first lead part may include a first lead connection area connected to the first contact part, a pattern area having a wrinkled shape extending from the first lead connection area in the first direction of the first lead part or a direction transverse to the first direction and a second lead connection area connected to the pattern area and disposed on an opposite side of the first lead connection area from the pattern area.

The pattern area may include a first pattern extending in the first direction along the first lead part from the first lead connection area, a second pattern connected to the first pattern and extending in a second direction along the first lead part, and a third pattern connected to the second pattern, and extending in the first direction of the first lead part.

One or more of the first pattern, the second pattern, and the third pattern may be configured to linearly extend along the first direction of the first lead part or in a direction transverse to the first direction or include a wrinkled shape extending along the first direction of the first lead part or in a direction transverse to the first direction.

A width of the pattern area in the first direction of the first lead part and the direction transverse to the first direction may be smaller than each of a width of the first lead connection area in the direction transverse to the first direction of the first lead part and a width of the second lead connection area in the direction transverse to the first direction.

The second lead part may include a first lead connection area connected to the second contact part, a pattern area having a wrinkled shape extending from the first lead connection area in a second direction of the second lead part or a direction transverse to the second direction, and a second lead connection area connected to the pattern area and disposed on an opposite side of the first lead connection area from the pattern area.

A width of the pattern area in the second direction of the second lead part and the direction transverse to the second direction may be smaller than each of a width of the first lead connection area in the direction transverse to the second direction of the second lead part and a width of the second lead connection area in the direction transverse to the second direction.

### BRIEF DESCRIPTION OF THE FIGURES

The above and other aspects, features and advantages of the present disclosure will be more apparent from the following detailed description taken in conjunction with the accompanying drawings:

FIG. 1 is an exploded perspective view of a pressure sensor according to one embodiment of the present disclosure;

FIG. 2 is a plan view of a pressure sensor according to one embodiment of the present disclosure;

FIG. 3 is a plan view of a pressure sensor according to another embodiment of the present disclosure;

FIG. 4 is a plan view of a pressure sensor according to another embodiment of the present disclosure;

FIG. 5 is a plan view of a pressure sensor according to another embodiment of the present disclosure;

FIG. 6 is a schematic view illustrating a principle of a pressure sensor according to first to another embodiments of the present disclosure; and

FIG. 7 is a series of graphs depicting a change value of a resistance according to a temperature of an electrode layer and a change value of a resistance according to a temperature of a pressure sensing layer for a principle of a pressure sensor according to embodiments of the present disclosure.

### DETAILED DESCRIPTION

Hereinafter, some embodiments of the present disclosure will be described in detail with reference to the accompanying drawings. In adding reference numerals to the components of the drawings, it should be noted that the same components have the same numerals when possible even when they are illustrated on different drawings. Furthermore, in describing the embodiments of the present disclosure, detailed descriptions associated with well- known functions or configurations will be omitted if they may make subject matters of the present disclosure unnecessarily obscure.

In describing components of embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

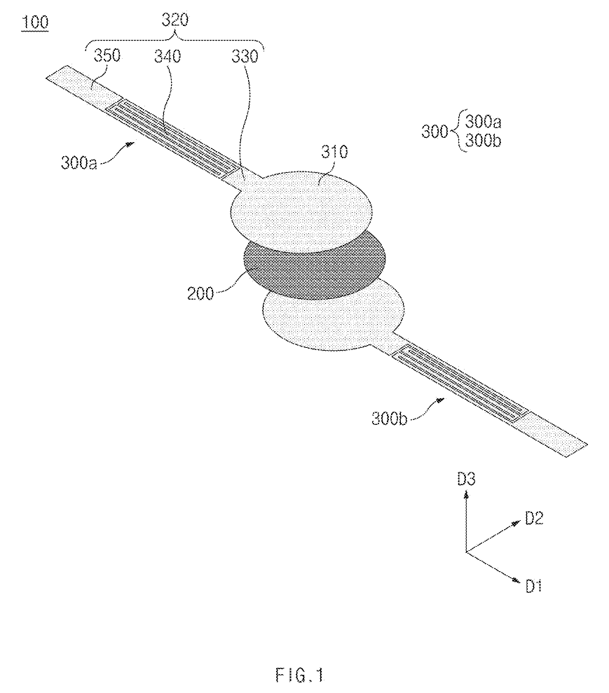

Hereinafter, embodiments of the present disclosure will be described in detail with reference to FIGS. 1 to 7. Hereinafter, a first direction (direction D1 or an opposite direction to direction D1) may be a lengthwise direction of a lead part, a second direction (direction D2 or an opposite direction to direction D2) may be a direction that is perpendicular to the lengthwise direction of a lead part 320, and a third direction (direction D3 or an opposite direction to direction D3) may be a direction, in which the components of pressure sensors 100, 100-1, 100-2, and 100-3 are stacked. The first direction (direction D1 or the opposite direction to direction D1), the second direction (direction D2 or the opposite direction to direction D2), and the third direction (direction D3 or the opposite direction to direction D3) may be directions that are perpendicular to each other.

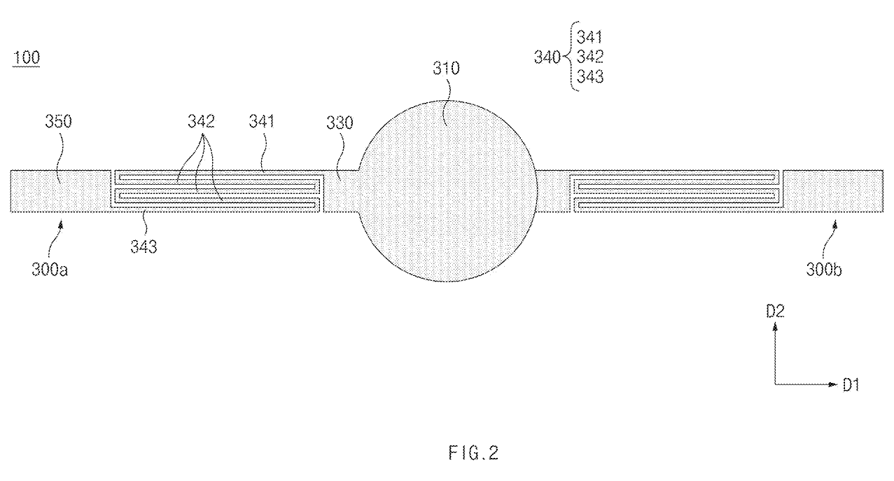

FIG. 1 is an exploded perspective view of a pressure sensor according to one embodiment of the present disclosure. FIG. 2 is a plan view of a pressure sensor according to one embodiment of the present disclosure.

Referring to FIGS. 1 and 2, the pressure sensor 100 may be a device for sensing a pressure of a contacting object that contacts the pressure sensor 100. As an example, the pressure sensor 100 may be a component for monitoring a pressure caused by swelling of a battery cell (not illustrated) in real time.

The pressure sensor 100 may be a piezoresistive sensor. The piezoresistive sensor may be a component for sensing a pressure by using a piezoresistive effect of changing an electrical resistance of a material when a pressure is applied.

The pressure sensor 100 may include a pressure sensing layer 200 that is formed to sense a pressure, and an electrode layer 300 that contacts the pressure sensing layer 200.

As described above, the pressure sensing layer 200 may be formed of a material, of which an electrical resistance is changed when a pressure is applied thereto. As an example, the pressure sensing layer 200 may be formed of carbon nanotubes (CNTs).

The electrode layer 300 may contact the pressure sensing layer 200. The electrode layer 300 may be formed of a metal electrode to receive an electrical resistance value of the pressure sensing layer 200. As an example, the electrode layer 300 may be formed of copper, silver, platinum, aluminum, or the like.

The electrode layers 300 may be disposed parallel to each other with the pressure sensing layer 200 interposed therebetween. The electrode layer 300 may include a first electrode layer 300a that is stacked on one surface of the pressure sensing layer 200 and a second electrode layer 300b that is stacked on an opposite surface of the pressure sensing layer 200.

Each of the first and second electrode layers 300a and 300b may transmit an electrical resistance value of the pressure sensing layer 200 disposed between the first and second electrode layers 300a and 300b to a processor (not illustrated).

The first and second electrode layers 300a and 300b may be stacked on the pressure sensing layer 200, respectively. Each of the first and second electrode layers 300a and 300b may include a contact part 310 that contacts the pressure sensing layer 200 and a lead part 320 that is connected to the contact part 310 and protrudes from the contact part 310.

As illustrated in the drawings, the pressure sensing layer 200 may be formed in a disk shape, and the contact part 310 may also be formed in a disk shape, but the present disclosure is not limited thereto.

Furthermore, the lead part 320 may be integrally formed with the contact part 310, and may protrude radially outward from the contact part 310.

Meanwhile, when a pressure is applied to the pressure sensing layer 200, the electrical resistance value of the pressure sensing layer 200 may be changed. The pressure sensing layer 200 may be affected by a change in a temperature of a contacting object or the ambient temperature, in addition to the pressure applied from the contacting object.

When the electrical resistance value of the pressure sensing layer 200 is changed due to the temperature in addition to the pressure applied to the pressure sensing layer 200, a value of the pressure sensed by the pressure sensor 100 may not be accurate.

To solve this problem, the pressure sensor 100 according to an embodiment of the present disclosure may include a pressure sensing layer 200, of which a temperature coefficient of resistance (TCR) according to a change in temperature is any one of a positive number or a negative number, and an electrode layer 300, of which a temperature coefficient of resistance (TCR) according to a change in temperature change is the other one of a positive number or a negative number.

Preferably, the temperature coefficient of resistance (TCR) according to the change in temperature of the pressure sensing layer 200 may be a negative number, and the temperature coefficient of resistance (TCR) according to the change in temperature of the electrode layer 300 may be a positive number.

Because the temperature coefficient of resistance (TCR) according to the change in temperature of the carbon nanotube (CNT) commonly used in the pressure sensing layer 200 is a negative number, the electrode layer 300 having the temperature coefficient of resistance TCR according to the change in temperature of a positive number for compensating for this may be used.

Unlike this, it is possible to have a structure, in which the temperature coefficient of resistance (TCR) according to the change in temperature of the pressure sensing layer 200 is a positive number and the temperature coefficient of resistance (TCR) according to the change in temperature of the electrode layer 300 is a negative number, but due to the excellent mechanical and electrical properties of the carbon nano tubes (CNTs) used in the pressure sensing layer 200, a structure, in which a temperature coefficient of resistance (TCR) according to a change in temperature of the pressure sensing layer 200 is a negative number and a temperature coefficient of resistance (TCR) according to a change in temperature of the electrode layer 300 is a positive number, may be preferable for the performance of the pressure sensor 100.

According to the structure, in which the electrode layer 300 includes the first electrode layer 300a and the second electrode layer 300b, an absolute value of the temperature coefficient of resistance (TCR) according to the change in temperature of the pressure sensing layer 200 may correspond to a sum of the temperature coefficient of resistance (TCR) according

to the change in temperature of the first electrode layer 300a and the temperature coefficient of resistance (TCR) according to the change in temperature of the second electrode layer 300b. The second lead connection area 350 of each of the first and second electrode layers 300a and 300b may be electrically connected to a processor (not illustrated), and the processor may calculate an electrical resistance value of the sensing layer 200 by using a potential received from the second lead connection area 350 of each of the first and second electrode layers 300a and 300b, and through this, the processor may calculate the pressure value of the pressure by the pressure sensor 100.

In other words, the absolute value of the temperature coefficient of resistance (TCR) according to the change in temperature of the pressure sensing layer 200 may be equal to the sum of the temperature coefficient of resistance (TCR) according to the change in temperature of the first electrode layer 300a and the temperature coefficient of resistance (TCR) according to the change in temperature of the second electrode layer 300b.

According to this structure, even when the temperature of the contacting object that contacts the pressure sensor 100 or the ambient temperature rises or falls, the change value of the electrical resistance according to the change in temperature of the electrode layer 200 may be offset by the change value of the electrical resistance according to the change in temperature of the electrode layer 300, so that the electrical resistance value calculated by the pressure sensor 100 may be an electrical resistance value only according to the pressure applied to the pressure sensing layer 200.

Accordingly, the pressure sensor 100 according to the one embodiment of the present disclosure may more accurately calculate the pressure applied to the pressure sensor 100 by using the electrical resistance value according to the pressure, thereby improving the accuracy of the pressure sensor 100.

Meanwhile, in order to adjust the change value of the electrical resistance according to the change in temperature of the electrode layer 300, the lead part 320 of the pressure sensor 100 may include a pattern area 340. The lead part 320 protrudes from the contact part 310 and may be provided in series with an electrically conductive path. That is, the lead part 320 may have a serpentine shape or a spiral pattern.

This may allow the change in the electrical resistance according to the change in temperature of the electrode layer 300 to be adjusted by providing a pattern on the lead part 320 of the electrode layer 300 and, at the same time, may allow a stable contact of the electrode layer 300 and the pressure sensing layer 200 not by providing a pattern in the contact part 310 of the electrode layer 300, thereby securing a structural stability of the pressure sensor 100.

More specifically, the lead part 320 may include a first lead connection area 330, a pattern area 340, and a second lead connection area 350.

The first lead connection area 330 may be a part that is connected to the contact part 310 and extends radially outward from the contact part 310.

The pattern area 340 may be a part that connects the first lead connection area 330 and the second lead connection area 350 between the first lead connection area 330 and the second lead connection area 350.

The pattern area 340 may be a part of the lead part 320 for controlling electrically conductive paths in series. That is, as the shape of the pattern area 340 is designed, a desired electrically conductive path of the electrode layer 300 may be adjusted to derive a change in the electrical resistance according to the change in temperature of a desired level of the electrode layer 300.

The pattern area 340 may extend in a straight line along the lengthwise direction (direction D1 or the opposite direction to direction D1) of the lead part 320 or a direction that crosses or is transverse to the lengthwise direction (direction D1 or the opposite direction to the direction D1) of the lead part 320.

The pattern area 340 may include a first pattern 341 including a part that extends from the first lead connection area 330 in one direction of the lengthwise direction (direction D1 or the opposite direction to direction D1) of the lead part 320, a second pattern 342 including a part that is connected to the first pattern 341 and extends in an opposite direction of the lengthwise direction (direction D1 or the opposite direction to direction D1) of the lead part 320, and a third pattern 343 including a part that is connected to the second pattern 342 and extends in the one direction of the lengthwise direction (direction D1 or the opposite direction to direction D1) of the lead part 320 again.

The first pattern 341 may be a part that extends from the first lead connection area 330 toward the second lead connection area 350 and extends in one direction (the opposite direction to direction D2) of the second direction while being spaced apart from the second lead connection area 350.

The second pattern 342 may be a part that extends from the first pattern 341 toward the first lead connection area 330, extends in one direction (the opposite direction to direction D2) of the second direction while being spaced apart from the first lead connection area 330, extends toward the second lead connection area 350 again, extends in the one direction (the opposite direction to direction D2) of the second direction while being spaced apart from the second lead connection area 350, and extends toward the first connection area 330 again.

The third pattern 343 may be a part that extends from the second pattern 342 in one direction (the opposite direction to direction D2) of the second direction and extends to the second lead connection area 350.

The second lead connection area 350 may be connected to the pattern area 340 to be disposed on the opposite side of the first lead connection area 330 from the pattern area 340.

A width of the pattern area 340 in the lengthwise direction (direction D1 or the opposite direction to direction D1) of the lead part 320 and the direction that crosses, or is transverse to, the lengthwise direction (direction D1 or the opposite direction to direction D1) of the lead part 320 may be smaller than each of a width of the first lead connection area 330 in the direction that crosses the lengthwise direction (direction D1 or the opposite direction to direction D1) of the lead part 320 and a width of the second connection area 350 in the direction that crosses the lengthwise direction (direction D1 or the opposite direction to direction D1) of the lead part 320.

In this way, the change value of the resistance according to the change in temperature of the lead part 320 may be adjusted through an entire length of the first to third patterns 341 to 343. However, the shapes of the first to third patterns 341 to 343 illustrated in FIG. 2 are not limited thereto, and a structure for allowing the change value of the resistance according to the change in temperature of the lead part 320 to compensate for the change value of the resistance according to the change in temperature of the pressure sensing layer 200 is sufficient.

For example, while being spaced apart from the first lead connection area 330 and the second lead connection area 350, the first to third patterns 341 to 343 may extend along not the one direction of the second direction but the opposite direction (D2 direction) of the second direction.

For example, because the potential difference transmitted to the processor through each of the first and second electrode layers 300a and 300b is a potential difference after the change in the electrical resistance due to the change in temperature is offset through the first and second electrode layers 300a and 300b of the pressure sensing layer 200, the pressure sensor 100 may more accurately calculate only the pressure value of the pressure by the pressure sensor 100 through the electrical resistance value according to the change in the pressure.

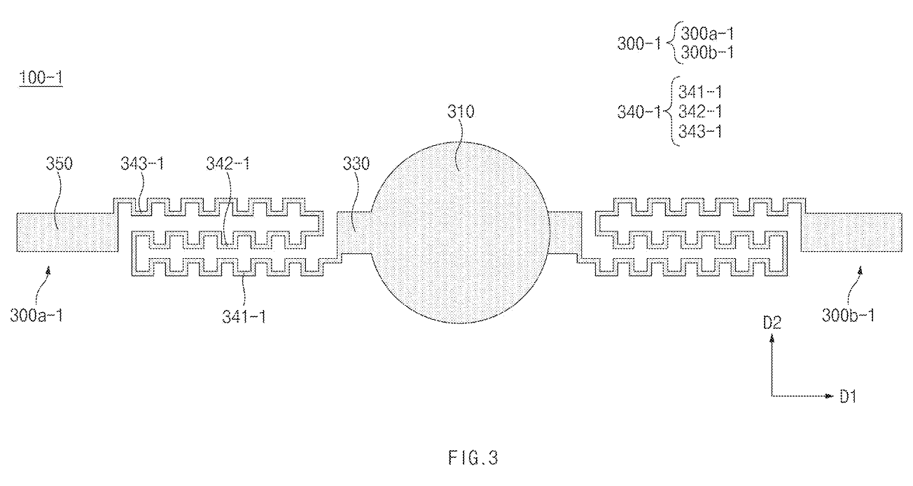

FIG. 3 is a plan view of a pressure sensor according to another embodiment of the present disclosure.

Referring to FIG. 3, the description and structure of pressure sensor 100-1 is the same as the description and structure of the pressure sensor 100, except for a pattern area 340-1 of the lead part 320 (see FIG. 2) is used.

The lead part 320 of the pressure sensor 100-1 may include a first lead connection area 330, a pattern area 340-1, and a second lead connection area 350.

The first lead connection area 330 may be a part that is connected to the contact part 310 and extends radially outward from the contact part 310.

The pattern area 340-1 may be a part that connects the first lead connection area 330 and the second lead connection area 350 between the first lead connection area 330 and the second lead connection area 350.

The pattern area 340-1 may be a part of the lead part 320 for controlling electrically conductive paths in series.

The pattern area 340-1 may have a wrinkled or folded shape from the first lead connection area 330 in the lengthwise direction (direction D1 or the opposite direction to direction D1) of the lead part 320 or the direction that crosses the lengthwise direction of the lead part 320.

The pattern area 340-1 may include a first pattern 341-1 including a part that is wrinkled from the first lead connection area 330 along one direction of the lengthwise direction (direction D1 or the opposite direction to direction D1) of the lead part 320, a second pattern 342 including a part that is connected to the first pattern 341-1 and is wrinkled along the opposite direction of the lengthwise direction (direction D1 or the opposite direction to direction D1) of the lead part 320, and a third pattern 343-1 including a part that is connected to the second pattern 342-1 and is wrinkled along the one direction of the lengthwise direction (direction D1 or the opposite direction to direction D1) of the lead part 320.

The first pattern 341-1 may be a part that extends to be wrinkled from the first lead connection area 330 toward the second lead connection area 350 and extends to be wrinkled in the opposite direction (direction D2) of the second direction while being spaced apart from the second lead connection area 350.

The second pattern 342-1 may be a part that extends to be wrinkled from the first pattern 341-1 toward the first lead connection area 330.

The third pattern 343-1 may be a part extends to be wrinkled from the second pattern 342-1 in the opposite direction (D2 direction) of the second direction and extends to be wrinkled to the second lead connection area 350.

The second lead connection area 350 may be connected to the pattern area 340-1 to be disposed on the opposite side of the first lead connection area 330 from the pattern area 340-1.

A width of the pattern area 340-1 in the lengthwise direction (direction D1 or the opposite direction to direction D1) of the lead part 320 and the direction that crosses the lengthwise direction (direction D1 or the opposite direction to direction D1) of the lead part 320 may be smaller than each of a width of the first lead connection area 330 in the direction that crosses the lengthwise direction (direction D1 or the opposite direction to direction D1) of the lead part 320 and a width of the second connection area 350 in the direction that crosses the lengthwise direction (direction D1 or the opposite direction to direction D1) of the lead part 320.

In this way, the change value of the resistance according to the change in temperature of the lead part 320 may be adjusted through an entire length of the first to third patterns 341-1 to 343-1. However, the shapes of the first to third patterns 341-1 to 343-1 illustrated in FIG. 3 are not limited thereto, and a structure for allowing the change value of the resistance according to the change in temperature of the lead part 320 to compensate for the change value of the resistance according to the change in temperature of the pressure sensing layer 200 is sufficient.

For example, while being spaced apart from the first lead connection area 330 and the second lead connection area 350, the first to third patterns 341-1 to 343-1 may extend along not the opposite direction of the second direction but the one direction (the opposite direction to D2 direction) of the second direction.

As illustrated in FIGS. 2 and 3, one or more of the first patterns 341 and 341-1, the second patterns 342 and 342-1, and the third patterns 343 and 343-1 may be configured to i) linearly extend along the lengthwise direction (direction D1 or the opposite direction to direction D1) of the lead part 320 or the direction that crosses the lengthwise direction (direction D1 or the opposite direction to direction D1) of the lead part 320, or ii) have a wrinkled shape along the lengthwise direction (direction D1 or the opposite direction to direction D1) of the lead part or the direction that crosses the lengthwise direction (direction D1 or the opposite direction to direction D1) of the lead part 320.

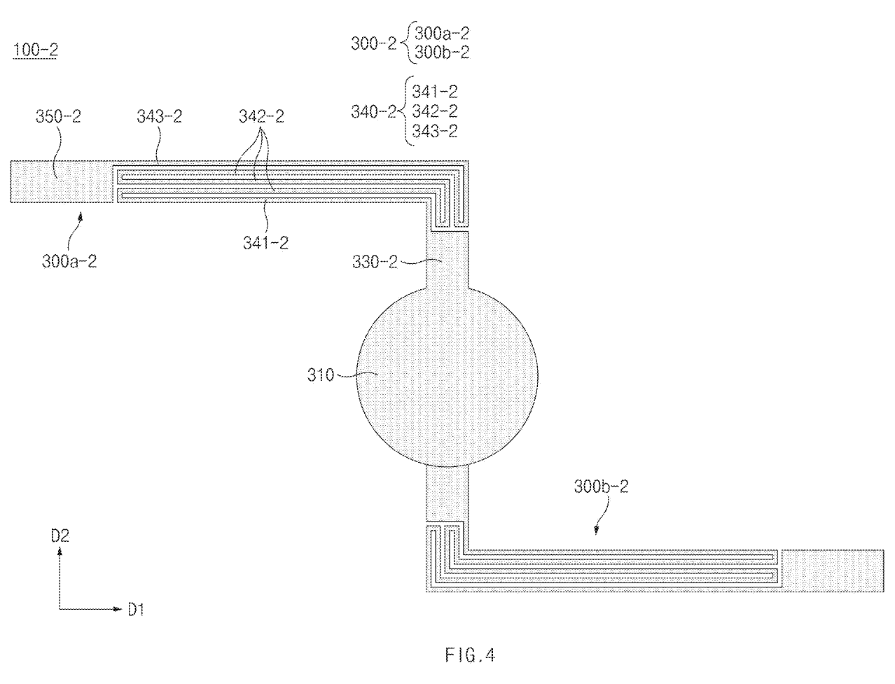

FIG. 4 is a plan view of a pressure sensor according to another embodiment of the present disclosure.

Referring to FIG. 4, the description and structure of pressure sensor 100-2 is the same as the description and structure of the pressure sensor 100, except for the lead part 320 (see FIG. 2) is used.

The lead part 320 may include a first lead connection area 330-2, a pattern area 340-2, and a second lead connection area 350-2.

The first lead connection area 330-2 may be a part that is connected to the contact part 310 and extends radially outward from the contact part 310.

The pattern area 340-2 may be a part that connects the first lead connection area 330-2 and the second lead connection area 350-2 between the first lead connection area 330-2 and the second lead connection area 350-2.

The pattern area 340-2 may be a part of the lead part 320 for controlling electrically conductive paths in series.

In particular, the first lead connection area 330-2 and the second lead connection area 350-2 of the pressure sensor 100-2 according to the another embodiment of the present disclosure may extend such that crossing directions thereof are lengthwise directions thereof.

The first lead connection area 330-2 may extend to a radially outer side of the contact part 310, and the second lead connection area 350-2 may extend such that a direction perpendicular to the lengthwise direction of the first lead connection area 330-2 is a lengthwise direction thereof.

The pattern areas 340-2 may extend parallel to the lengthwise direction of the first lead connection area 330-2 and the lengthwise direction of the second lead connection area 350-2, so each of them may extend in a straight line.

The pattern area 340-2 may include a first pattern 341-2 that is connected to the first lead connection area 330-2, a third pattern 343-2 that is connected to the second lead connection area 350-2, and a second pattern 342-2 that connects the first pattern 341-2 and the third pattern 343-2.

The first pattern 341-2 may be a part that extends from the first lead connection area 330-2 along the lengthwise direction of the first lead connection area 330-2, extends toward the second lead connection area 350-2, and extends in the lengthwise direction of the first lead connection area 330-2 while being spaced apart from the second lead connection area 350-2.

The second pattern 342-2 may include a part that extends from the first pattern 341-2 to become more distant from the second lead connection area 350-2, extends toward the first lead connection area 330-1, extends parallel to the first lead connection area 330-1 while being spaced apart from the first lead connection area 330-1, and becomes more distant from the first lead connection area 330-1.

The second pattern 342-2 may include a part that extends in the lengthwise direction of the first lead connection area 330-1 to become more distant from the first lead connection area 330-1, extends toward the second lead connection area 350-2, and extends parallel to the second lead connection area 350-2 while being spaced apart from the second lead connection area 350-2.

The second pattern 342-2 may include a part that extends again in a direction that becomes more distant from the second lead connection area 350-2, from a part that extends parallel to the second lead connection area 350-2, again and extends toward the first lead connection area 330-1.

The third pattern 343-2 may be a part that extends parallel to the first lead connection area 330-2 while being spaced apart from the first lead connection area 330-2, from the second pattern 342-2, extends to become more distant from the first lead connection area 330-2 along the lengthwise direction of the first lead connection area 330-2, and extends to the second lead connection area 350-2 along the lengthwise direction of the second lead connection area 350-2.

A width of the pattern area 340-2 in the lengthwise direction (direction D2 or an opposite direction to direction D2) of the first lead connection area 330-2 and the lengthwise direction (direction D1 or an opposite direction to direction D1) of the second lead connection area 350-2 may be smaller than each of the width of the first lead connection area 330-2 in a lengthwise direction (direction D1 or an opposite direction to direction D1) of the second lead connection area 350-2 and the width of the second lead connection area 350-2 in the lengthwise direction (direction D2 or an opposite direction to direction D2n) of the first lead connection area 330-2.

In this way, the change value of the resistance according to the change in temperature of the lead part 320 may be adjusted through an entire length of the first to third patterns 341-2 to 343-2. However, the shapes of the first to third patterns 341-2 to 343-2 illustrated in FIG. 4 are not limited thereto, and a structure for allowing the change value of the resistance according to the change in temperature of the lead part 320 to compensate for the change value of the resistance according to the change in temperature of the pressure sensing layer 200 is sufficient.

As an example, a direction, in which each of the first to third patterns 341-2 to 343-2 extends, may be formed opposite to the direction illustrated in FIG. 4. That is, the first pattern 341-2, the second pattern 342-2, and the third pattern 343-2 may be sequentially arranged counterclockwise.

As such, each of one or more of the first pattern 341-2, the second pattern 342-2, and the third pattern 343-2 may include a part that extends parallel to the lengthwise direction of the first lead connection area 330-2 and the lengthwise direction of the second lead connection area 350-2.

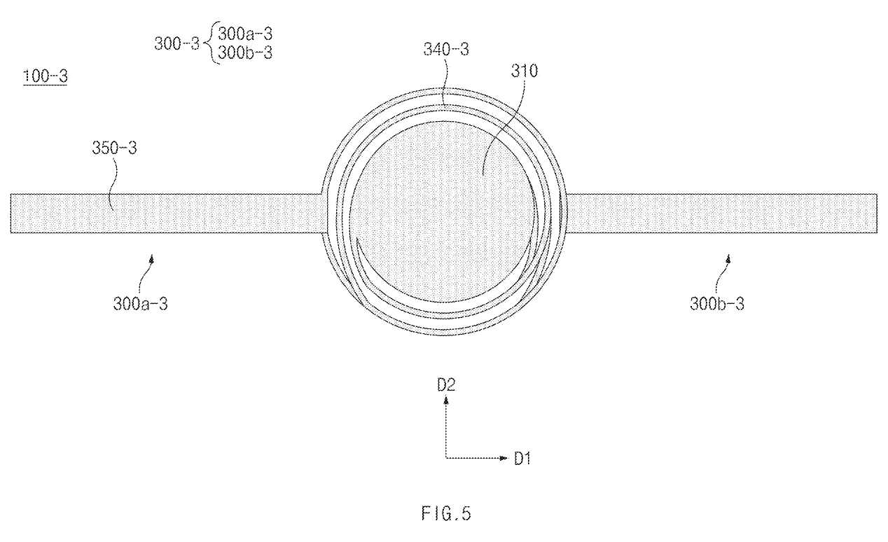

FIG. 5 is a plan view of a pressure sensor according to another embodiment of the present disclosure.

Referring to FIG. 5, a description and structure of pressure sensor 100-3 is the same as the description and structure of the pressure sensor 100, except for the lead part 320 (see FIG. 2) is used.

The contact part 310 of the pressure sensor 100-3 may have a circular shape. The lead part 320 may include a pattern area 340-3 that protrudes from the contact part 310 and extends spirally along a circumferential direction of the contact part 310 and a connection area 350-3 that extending to a radially outer side of the contact part 310 from the pattern area 340-3.

For example, the pattern area 340-3 may extend to surround the contact part 310 from a radially outer side of the contact part 310, and may extend spirally in an area, a radius of which becomes larger gradually.

The pattern area 340-3 may include one end part that is connected to the contact part 310 and an opposite end part that is located on a radially outer side of the contact part 310 than the one end part.

The connection area 350-3 may extend to a radially outer side of the contact part 310 along a linear shape from the opposites end part of the pattern area 340-3.

Even with this structure, it is possible to adjust the change value of the resistance according to the change in temperature of the electrode layer 300 through the length of the pattern area 340-3.

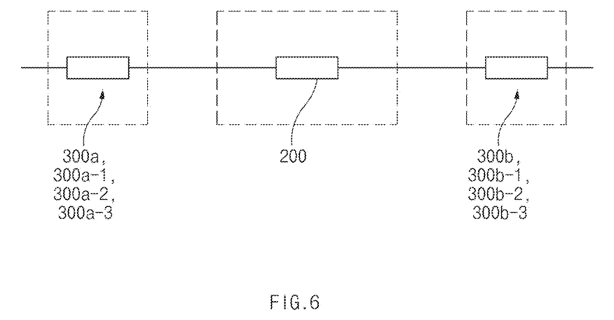

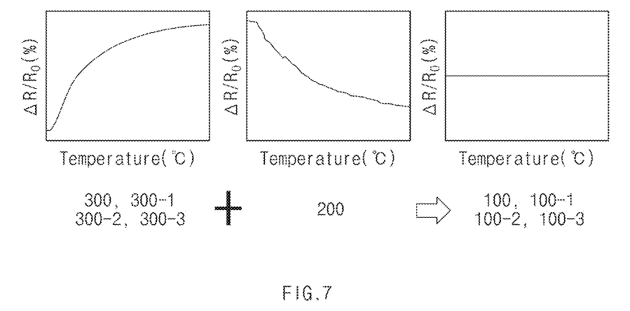

FIG. 6 is a schematic view illustrating a principle of a pressure sensor according to embodiments of the present disclosure. FIG. 7 is a graph depicting a change value of a resistance according to a temperature of an electrode layer and a change value of a resistance according to a temperature of a pressure sensing layer for a principle of a pressure sensor according to embodiments of the present disclosure.

The second lead connection area 350 may be connected to the pattern area 340-1 to be disposed on the opposite side of the first lead connection area 330 from the pattern area 340-1.

A width of the pattern area 340-1 in the lengthwise direction (direction D1 or the opposite direction to direction D1) of the lead part 320 and the direction that crosses the lengthwise direction (direction D1 or the opposite direction to direction D1) of the lead part 320 may be smaller than each of a width of the first lead connection area 330 in the direction that crosses the lengthwise direction (direction D1 or the opposite direction to direction D1) of the lead part 320 and a width of the second connection area 350 in the direction that crosses the lengthwise direction (direction D1 or the opposite direction to direction D1) of the lead part 320.

In this way, the change value of the resistance according to the change in temperature of the lead part 320 may be adjusted through an entire length of the first to third patterns 341-1 to 343-1. However, the shapes of the first to third patterns 341-1 to 343-1 illustrated in FIG. 3 are not limited thereto, and a structure for allowing the change value of the resistance according to the change in temperature of the lead part 320 to compensate for the change value of the resistance according to the change in temperature of the pressure sensing layer 200 is sufficient.

For example, while being spaced apart from the first lead connection area 330 and the second lead connection area 350, the first to third patterns 341-1 to 343-1 may extend along not the opposite direction of the second direction but the one direction (the opposite direction to D2 direction) of the second direction.

As illustrated in FIGS. 2 and 3, one or more of the first patterns 341 and 341-1, the second patterns 342 and 342-1, and the third patterns 343 and 343-1 may be configured to i) linearly extend along the lengthwise direction (direction D1 or the opposite direction to direction D1) of the lead part 320 or the direction that crosses the lengthwise direction (direction D1 or the opposite direction to direction D1) of the lead part 320, or ii) have a wrinkled shape along the lengthwise direction (direction D1 or the opposite direction to direction D1) of the lead part or the direction that crosses the lengthwise direction (direction D1 or the opposite direction to direction D1) of the lead part 320.

FIG. 4 is a plan view of a pressure sensor according to another embodiment of the present disclosure.

Referring to FIG. 4, the description and structure of pressure sensor 100-2 is the same as the description and structure of the pressure sensor 100, except for the lead part 320 (see FIG. 2) is used.

The lead part 320 may include a first lead connection area 330-2, a pattern area 340-2, and a second lead connection area 350-2.

The first lead connection area 330-2 may be a part that is connected to the contact part 310 and extends radially outward from the contact part 310.

The pattern area 340-2 may be a part that connects the first lead connection area 330-2 and the second lead connection area 350-2 between the first lead connection area 330-2 and the second lead connection area 350-2.

The pattern area 340-2 may be a part of the lead part 320 for controlling electrically conductive paths in series.

In particular, the first lead connection area 330-2 and the second lead connection area 350-2 of the pressure sensor 100-2 according to the another embodiment of the present disclosure may extend such that crossing directions thereof are lengthwise directions thereof.

The first lead connection area 330-2 may extend to a radially outer side of the contact part 310, and the second lead connection area 350-2 may extend such that a direction perpendicular to the lengthwise direction of the first lead connection area 330-2 is a lengthwise direction thereof.

The pattern areas 340-2 may extend parallel to the lengthwise direction of the first lead connection area 330-2 and the lengthwise direction of the second lead connection area 350-2, so each of them may extend in a straight line.

The pattern area 340-2 may include a first pattern 341-2 that is connected to the first lead connection area 330-2, a third pattern 343-2 that is connected to the second lead connection area 350-2, and a second pattern 342-2 that connects the first pattern 341-2 and the third pattern 343-2.

The first pattern 341-2 may be a part that extends from the first lead connection area 330-2 along the lengthwise direction of the first lead connection area 330-2, extends toward the second lead connection area 350-2, and extends in the lengthwise direction of the first lead connection area 330-2 while being spaced apart from the second lead connection area 350-2.

The second pattern 342-2 may include a part that extends from the first pattern 341-2 to become more distant from the second lead connection area 350-2, extends toward the first lead connection area 330-1, extends parallel to the first lead connection area 330-1 while being spaced apart from the first lead connection area 330-1, and becomes more distant from the first lead connection area 330-1.

The second pattern 342-2 may include a part that extends in the lengthwise direction of the first lead connection area 330-1 to become more distant from the first lead connection area 330-1, extends toward the second lead connection area 350-2, and extends parallel to the second lead connection area 350-2 while being spaced apart from the second lead connection area 350-2.

The second pattern 342-2 may include a part that extends again in a direction that becomes more distant from the second lead connection area 350-2, from a part that extends parallel to the second lead connection area 350-2, again and extends toward the first lead connection area 330-1.

The third pattern 343-2 may be a part that extends parallel to the first lead connection area 330-2 while being spaced apart from the first lead connection area 330-2, from the second pattern 342-2, extends to become more distant from the first lead connection area 330-2 along the lengthwise direction of the first lead connection area 330-2, and extends to the second lead connection area 350-2 along the lengthwise direction of the second lead connection area 350-2.

A width of the pattern area 340-2 in the lengthwise direction (direction D2 or an opposite direction to direction D2) of the first lead connection area 330-2 and the lengthwise direction (direction D1 or an opposite direction to direction D1) of the second lead connection area 350-2 may be smaller than each of the width of the first lead connection area 330-2 in a lengthwise direction (direction D1 or an opposite direction to direction D1) of the second lead connection area 350-2 and the width of the second lead connection area 350-2 in the lengthwise direction (direction D2 or an opposite direction to direction D2n) of the first lead connection area 330-2.

In this way, the change value of the resistance according to the change in temperature of the lead part 320 may be adjusted through an entire length of the first to third patterns 341-2 to 343-2. However, the shapes of the first to third patterns 341-2 to 343-2 illustrated in FIG. 4 are not limited thereto, and a structure for allowing the change value of the resistance according to the change in temperature of the lead part 320 to compensate for the change value of the resistance according to the change in temperature of the pressure sensing layer 200 is sufficient.

As an example, a direction, in which each of the first to third patterns 341-2 to 343-2 extends, may be formed opposite to the direction illustrated in FIG. 4. That is, the first pattern 341-2, the second pattern 342-2, and the third pattern 343-2 may be sequentially arranged counterclockwise.

As such, each of one or more of the first pattern 341-2, the second pattern 342-2, and the third pattern 343-2 may include a part that extends parallel to the lengthwise direction of the first lead connection area 330-2 and the lengthwise direction of the second lead connection area 350-2.

FIG. 5 is a plan view of a pressure sensor according to another embodiment of the present disclosure.

Referring to FIG. 5, a description and structure of pressure sensor 100-3 is the same as the description and structure of the pressure sensor 100, except for the lead part 320 (see FIG. 2) is used.

The contact part 310 of the pressure sensor 100-3 may have a circular shape. The lead part 320 may include a pattern area 340-3 that protrudes from the contact part 310 and extends spirally along a circumferential direction of the contact part 310 and a connection area 350-3 that extending to a radially outer side of the contact part 310 from the pattern area 340-3.

For example, the pattern area 340-3 may extend to surround the contact part 310 from a radially outer side of the contact part 310, and may extend spirally in an area, a radius of which becomes larger gradually.

The pattern area 340-3 may include one end part that is connected to the contact part 310 and an opposite end part that is located on a radially outer side of the contact part 310 than the one end part.

The connection area 350-3 may extend to a radially outer side of the contact part 310 along a linear shape from the opposites end part of the pattern area 340-3.

Even with this structure, it is possible to adjust the change value of the resistance according to the change in temperature of the electrode layer 300 through the length of the pattern area 340-3.

FIG. 6 is a schematic view illustrating a principle of a pressure sensor according to embodiments of the present disclosure. FIG. 7 is a graph depicting a change value of a resistance according to a temperature of an electrode layer and a change value of a resistance according to a temperature of a pressure sensing layer for a principle of a pressure sensor according to embodiments of the present disclosure.

1. A pressure sensor comprising:
a pressure sensing layer configured to sense a pressure, the pressure sensing layer having a temperature coefficient of resistance (TCR) according to a change in temperature which is a positive number or a negative number; and
an electrode layer contacting the pressure sensing layer, the electrode layer having a TCR according to a change in temperature is which is opposite to the TCR of the pressure sensing layer;
wherein the electrode layer includes:
a contact part stacked on the pressure sensing layer, and contacting the pressure sensing layer; and
a lead part protruding from the contact part, and having either a serpentine shape or a spiral pattern.

2. The pressure sensor of claim 1, wherein the TCR of the pressure sensing layer is a negative number, and wherein the TCR of the electrode layer is a positive number.

3. The pressure sensor of claim 2, wherein the electrode layer includes:
a first electrode layer stacked on a first surface of the pressure sensing layer; and
a second electrode layer stacked on a second surface of the pressure sensing layer;
wherein an absolute value of the TCR of the pressure sensing layer corresponds to a sum of the TCR of the first electrode layer and the TCR of the second electrode layer.

4. The pressure sensor of claim 1, wherein the lead part includes:
a first lead connection area connected to the contact part;
a pattern area having a wrinkled shape extending from the first lead connection area in a lengthwise direction of the lead part or a direction transverse to the lengthwise direction of the lead part; and
a second lead connection area connected to the pattern area and disposed on an opposite side of the first lead connection area from the pattern area.

5. The pressure sensor of claim 4, wherein a width of the pattern area in the lengthwise direction of the lead part and the direction transverse to the lengthwise direction of the lead part is smaller than each of a width of the first lead connection area in the direction transverse to the lengthwise direction of the lead part and a width of the second lead connection area in the direction transverse to the lengthwise direction of the lead part.

6. The pressure sensor of claim 4, wherein the pattern area includes:
a first pattern extending in a first direction along the lengthwise direction of the lead part from the first lead connection area;
a second pattern connected to the first pattern, and extending in a second direction along the lead part; and
a third pattern connected to the second pattern, and extending in the first direction along the lengthwise direction of the lead part.

7. The pressure sensor of claim 6, wherein one or more of the first pattern, the second pattern, and the third pattern is configured to:
linearly extend along the lengthwise direction of the lead part or in the direction transverse to the lengthwise direction of the lead part; or
include a wrinkled shape along the lengthwise direction of the lead part or in the direction transverse to the lengthwise direction of the lead part.

8. The pressure sensor of claim 6, wherein the first lead connection area and the second lead connection area extend such that transverse directions of the first lead connection area and the second lead connection area are lengthwise directions; and
wherein one or more of the first pattern, the second pattern, and the third pattern includes parts extending parallel to a lengthwise direction of the first lead connection area and a lengthwise direction of the second lead connection area.

9. The pressure sensor of claim 1, wherein the contact part includes a circular shape, and wherein the lead part includes:
a pattern area extending spirally along a circumferential direction of the contact part; and
a connection area extending to a radially outer side of the contact part from the pattern area.

10. A pressure sensor comprising:
a first electrode layer comprising a first contact part and a first lead part extending from the first contact part in a first direction;
a second electrode layer comprising a second contact part and a second lead part extending from the second contact part in a second direction being opposite the first direction; and
a pressure sensing layer positioned between the first electrode layer and the second electrode layer;
wherein the pressure sensing layer includes a temperature coefficient of resistance (TCR) according to a change in temperature;
wherein the first electrode layer includes a TCR according to a change in temperature;
wherein the second electrode layer includes a TCR according to a change in temperature; and
wherein an absolute value of the TCR of the pressure sensing layer corresponds to a sum of the TCR of the first electrode layer and the TCR of the second electrode layer.

11. The pressure sensor of claim 10, wherein the pressure sensing layer, the first contact part, and the second contact part each include a circular shape, and wherein the first lead part and the second lead part each have either a serpentine shape or a spiral pattern.

12. The pressure sensor of claim 10, wherein the first lead part includes a pattern area extending spirally along a circumferential direction of the first contact part, and a connection area extending to a radially outer side of the first contact part from the pattern area, and wherein the second lead part includes a pattern area extending spirally along a circumferential direction of the second contact part, and a connection area extending to a radially outer side of the first contact part from the pattern area.

13. The pressure sensor of claim 10, wherein the first lead part includes:
a first lead connection area connected to the first contact part;
a pattern area having a wrinkled shape extending from the first lead connection area in the first direction of the first lead part or a direction transverse to the first direction; and
a second lead connection area connected to the pattern area and disposed on an opposite side of the first lead connection area from the pattern area.

14. The pressure sensor of claim 13, wherein the pattern area includes:
a first pattern extending in the first direction along the first lead part from the first lead connection area;
a second pattern connected to the first pattern, and extending in a second direction along the first lead part; and
a third pattern connected to the second pattern, and extending in the first direction of the first lead part.

15. The pressure sensor of claim 14, wherein one or more of the first pattern, the second pattern, and the third pattern is configured to:
linearly extend along the first direction of the first lead part or in a direction transverse to the first direction; or
include a wrinkled shape extending along the first direction of the first lead part or in a direction transverse to the first direction.

16. The pressure sensor of claim 13, wherein a width of the pattern area in the first direction of the first lead part and the direction transverse to the first direction is smaller than each of a width of the first lead connection area in the direction transverse to the first direction of the first lead part and a width of the second lead connection area in the direction transverse to the first direction.

17. The pressure sensor of claim 10, wherein the second lead part includes:
a first lead connection area connected to the second contact part;
a pattern area having a wrinkled shape extending from the first lead connection area in a second direction of the second lead part or a direction transverse to the second direction; and
a second lead connection area connected to the pattern area and disposed on an opposite side of the first lead connection area from the pattern area.

18. The pressure sensor of claim 17, wherein a width of the pattern area in the second direction of the second lead part and the direction transverse to the second direction is smaller than each of a width of the first lead connection area in the direction transverse to the second direction of the second lead part and a width of the second lead connection area in the direction transverse to the second direction.
